(19) United States
(12) Patent Application Publication
(10) Pub. No.: US 2026/0012748 A1
(43) Pub. Date: Jan. 8, 2026

(54) SYSTEM AND METHOD FOR PROVIDING LOCATION DETERMINATION SERVICES

(71) Applicant: JIO PLATFORMS LIMITED, Ahmedabad, Gujarat (IN)

(72) Inventors: Aayush BHATNAGAR, Navi Mumbai, Maharashtra (IN); Vikash AGRAWAL, Navi Mumbai, Maharashtra (IN); Omprakash KUSHWAH, Ashok Nagar, Madhya Pradesh (IN); Vikram LIMAN, Navi Mumbai, Maharashtra (IN); Pramila KASAR, Yeola Nashik, Maharashtra (IN)

(73) Assignee: JIO PLATFORMS LIMITED, Ahmedabad, Gujarat (IN)

(21) Appl. No.: 18/881,347

(22) PCT Filed: Mar. 5, 2024
(86) PCT No.: PCT/IN2024/050230

§ 371 Date: Jan. 6, 2025

(30) Foreign Application Priority Data
Mar. 31, 2023 (IN) 202321024517

(51) Int. Cl. H04W 4/02

(52) U.S. Cl. CPC H04W 4/02

(57) ABSTRACT

The present invention discloses a system for providing location services in a network. The method comprising sending, by at least one network element, a location assistance request to at least one GMLC node. The method comprising requesting, by the at least one GMLC node (112), an information related to a user equipment the (UE) based on the received location assistance request, from at least one unified data management (UDM) (108). The information includes a routing information and a privacy information of the UE. The method comprising receiving, by the at least one GMLC node, the requested information from the at least one UDM. The method comprising verifying, by the at least one GMLC node, a privacy profile of the UE based on the received requested information. The method comprising delivering, by the at least one GMLC node, the location information of the UE to the at least one network element.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of communication technology, and specifically to a system and a method for providing location determination services.

### DEFINITION

As used in the present disclosure, the following terms are generally intended to have the meaning as set forth below, except to the extent that the context in which they are used to indicate otherwise.

The term UDM as used herein, refers to unified data management. The UDM manages network user data in a single and centralized element.

The term AMF as used herein, refers to access and mobility management function. The AMF is responsible for managing access and mobility for 5G devices, and it interacts with other network functions such as the UPF (User Plane Function), SMF (Session Management Function), and AUSF (Authentication Server Function).

The term NEF as used herein, refers to Network Exposure Function. The NEF exposes unified application programming interface (APIs) to any other external business applications for interaction with the 5G network functions. It provides interfaces for monitoring, provisioning, and policy/charging functionalities in the 5G network.

The term GMLC as used herein, refers to gateway mobile location center. The 5G uses the GMLC which provides the location of the base station currently serving the subscriber, but not the handset itself.

The term HSS as used herein, refers to home subscriber server. The HSS is the main database of the current generation's cellular communications systems. It contains subscriber-related information, such as the authentication information and the list of services to which each user is subscribed.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Wireless communication technology has rapidly evolved over the past few decades. The first generation of wireless communication technology was analog technology that offered only voice services. Further, when the second-generation (2G) technology was introduced, text messaging and data services became possible. The 3G technology marked the introduction of high-speed internet access, mobile video calling, and location-based services. The fourth generation (4G) technology revolutionized the wireless communication with faster data speeds, improved network coverage, and security. Currently, the fifth generation (5G) technology is being deployed, with even faster data speeds, low latency, and the ability to connect multiple devices simultaneously.

Available Gateway Mobile Location Center (GMLC) architecture provided by 3rd Generation Partnership Project (3GPP) involves using multiple interconnected units. The independent units are connected with external nodes leading to execution dependency and leading to a decreased reliability of the network.

There is, therefore, a need in the art for an improved architecture that consists of multiple units running independently and that can lead to more network reliability.

### OBJECTS OF THE PRESENT DISCLOSURE

It is an object of the present disclosure to provide a system and a method for providing location determination services.

It is an object of the present disclosure to provide a plurality of microservices connected via a data structure.

It is an object of the present disclosure to provide a Gateway Mobile Location Center (GMLC) architecture that consists of multiple units running independently.

It is an object of the present disclosure to enable development, updation, deployment and scaling of each of the plurality of microservices without affecting other services.

It is an object of the present disclosure to perform software updates more frequently, with improved reliability, uptime, and performance.

It is an object of the present disclosure to facilitate location related services individually with each of the connected nodes in the system.

### SUMMARY

In an exemplary embodiment, the present invention discloses a method for providing location services in a network comprising a plurality of gateway mobile location center (GMLC) nodes. The method comprising sending, by at least one network element, a location assistance request to at least one GMLC node. The method comprising requesting, by the at least one GMLC node, an information related to a user equipment the (UE) based on the received location assistance request, from at least one unified data management (UDM). The information includes a routing information and a privacy information of the UE. The method comprising receiving, by the at least one GMLC node, the requested information from the at least one UDM. The method comprising verifying, by the at least one GMLC node, a privacy profile of the UE based on the received requested information. The method comprising delivering, by the at least one GMLC node, the location information of the UE to the at least one network element.

In some embodiments, the at least one network element includes a location services (LCS) client, at least one access and mobility management function serving (AMF), and at least one network exposure function (NEF).

In some embodiments, the method further comprising determining if the received location assistance request is a 4G request or a 5G request.

In some embodiments, the method further comprising performing, by the at least one GMLC node, an authorization of the at least one network element before delivering the location information of the UE.

In some embodiments, each GMLC node of the plurality of GMLC nodes is connected independently to different network elements connected to the network.

In an exemplary embodiment, the present invention discloses a system for providing location services in a network comprising a plurality of gateway mobile location center (GMLC) nodes. The system is configured to send, by at least one network element, a location assistance request to at least one GMLC node. The system is configured to request, by the at least one GMLC node, an information related to a user equipment the (UE) based on the received location assistance request, from at least one unified data management (UDM). The information includes a routing information and a privacy information of the UE. The system is configured to receive, by the at least one GMLC node, the requested information from the at least one UDM. The system is configured to verify, by the at least one GMLC node, a privacy profile of the UE based on the received requested information. The system is configured to deliver, by the at least one GMLC node, the location information of the UE to the at least one network element.

In some embodiments, the at least one network element includes a location services (LCS) client, at least one access and mobility management function serving (AMF), and at least one network exposure function (NEF).

In some embodiments, the system is further configured to determine if the received location assistance request is a 4G request or a 5G request.

In some embodiments, the system is further configured to determine perform, by the at least one GMLC node, an authorization of the at least one network element before delivering the location information of the UE.

In some embodiments, each GMLC node of the plurality of GMLC nodes is connected independently to different network elements connected to the network.

The foregoing general description of the illustrative embodiments and the following detailed description thereof are merely exemplary aspects of the teachings of this disclosure and are not restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates a prevailing architecture of Gateway Mobile Location Centre (GMLC).

FIG. 2 illustrates an advanced GMLC architecture, in accordance with an embodiment of the present disclosure.

FIG. 3 illustrates an end-to-end call flow for executing Mobile Terminating-Location Request (MT-LR) procedure, in accordance with an embodiment of the present disclosure.

FIG. 4 illustrates an end-to-end call flow for executing Mobile Originating-Location Request (MO-LR) procedure, in accordance with an embodiment of the present disclosure.

FIG. 5 illustrates an end-to-end call flow for executing Network Induced Location Request (NI-LR) procedure, in accordance with an embodiment of the present disclosure.

FIG. 6 illustrates an exemplary computer system in which or with which embodiments of the present disclosure may be implemented.

### LIST OF REFERENCE NUMERALS

100—System
102—User Equipment
104—Access and Mobility Management Function (AMF)
106—Location Management Function (LMF)
108—Unified Data Management (UDM) 110—Network Exposure Function (NEF)
112, 208—Gateway Mobile Location Center (GMLC)
114—Location Retrieval Function (LRF)
116—Location Services (LCS) Client
120—Home Subscriber Server (HSS)
122—Mobility Management Entity (MME)
124—Application Function (AF)
126—Radio Access Network (RAN)
200—An advanced GMLC architecture according to the present disclosure
202—Network Management System (NMS)
204—Operations And Management (OAM)
210—Database
300—Flow diagram
400—Flow diagram
500—Flow diagram
600—A computer system
610—External storage device
620—Bus
630—Main memory
640—Read only memory
650—Mass storage device
660—Communication port(s)
670—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skills in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

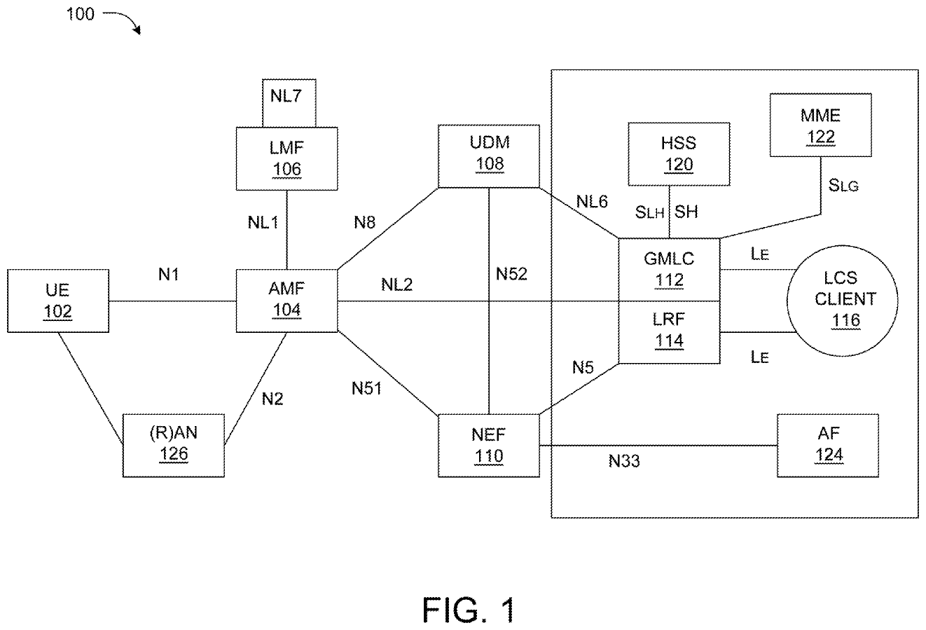

FIG. 1 illustrates a prevailing Gateway Mobile Location Centre Local Exchange (GMLC) architecture 100. The prevailing architecture uses multiple interconnected interdependent units that are connected with external nodes leading to execution dependency.

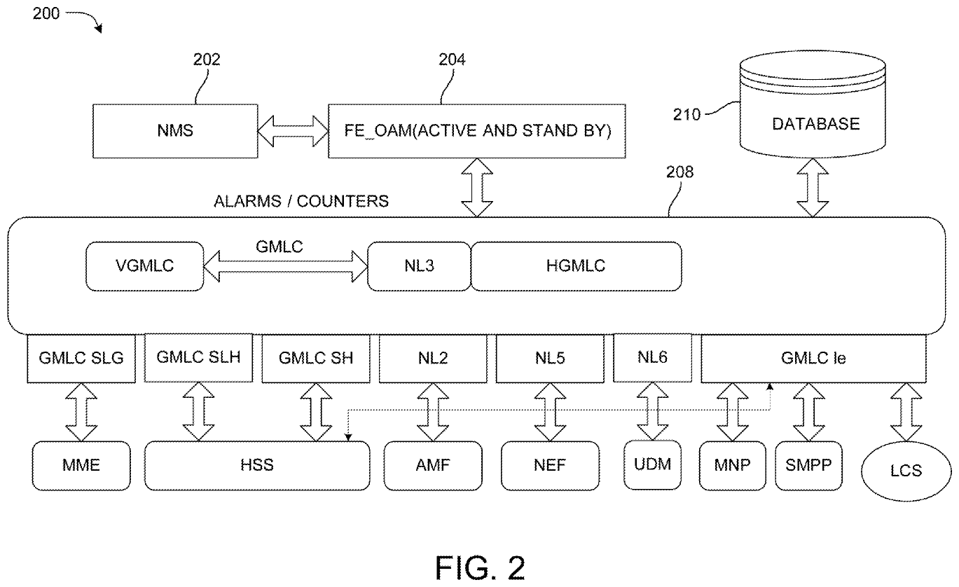

FIG. 2 illustrates an advanced GMLC architecture 200, in accordance with an embodiment of the present disclosure.

The disclosed system and method relate to providing location determination services in a network. Plurality of provided location determination microservices are connected via a data structure. Each of the provided microservices is developed, updated, deployed, and scaled without affecting other services. Also, is disclosed a GMLC architecture that consists of various units that run independently. Software updates for the GMLC architecture are performed frequently, with improved reliability, uptime, and performance.

The disclosed system may have a plurality of microservices such as a Gateway Mobile Location Centre Local Exchange (GMLC LE), a Gateway Mobile Location Centre Access and Mobility Management Function (GMLC AMF), a Gateway Mobile Location Centre Unified Data Management (GMLC UDM), and a Gateway Mobile Location Centre Network Exposure Function (GMLC NEF) that are connected via the data structure.

The GMLC microservices are provided as sub nodes of the GMLC architecture, and the GMLC microservices are attached individually with different nodes, specifically for each of external connected nodes leading to forming the GMLC architecture that is a control plane system that interfaces with emergency, regulatory and commercial Location Service (LCS) clients and the operator's network to quickly and efficiently provide location of a mobile device, required to support Location Based Services (LBS). All sub GMLCs are connected with the GMLC LE interface for communicating the location information. In the disclosed architecture, GMLC SLg/SLh/SH are 4G request nodes, NL2/NL5/NL6 are 5G nodes, and NL6 helps in determining an incoming request if it is 5G or 4G. The 4G request is a request for a 4G customer. The 5G request is a request for a 5G customer. The micro services of GMLC plays a role in identification of the access and mobility management function (AMF) for the 5G request and the home subscriber server (HSS) for 4G. The GMLC receives a successful response for an incoming request from the HSS when the incoming request is a 4G request. Further, the GMLC receives a successful response for an incoming request from the unified data management (UDM) when the incoming request is a 5G request.
GMLC LE: The GMLC LE is the microservice that interacts with the LCS client for performing location determination services.
GMLC NLS: The GMLC NLS is the microservice that interacts with a Unified Data Management (UDM) node to obtain get-privacy-data and get-amfId request.
GMLC NLF: The GMLC NLF is the microservice that interacts with a Network Exposure Function (NEF) node for performing location determination services.
GMLC NLT: The GMLC NLT is the microservice that interacts with the AMF to obtain location details from Location Management Function (LMF).
GMLS SH: The GMLC SH is the microservice that interacts with Home Subscriber Server (HSS) for UDR requests.
GMLC SLG: The GMLC SLG is the microservice that interacts with Mobility Management Entity (MME) to get location details from Evolved Serving Mobile Location Center (ESMLC). The GMLC SLG is an interface between the GMLC and the MME.
GMLC SLH: The GMLC SLH is the microservice that interacts with the HSS for a Regional Internet Registry (RIR) request. When a request is initiated by the GMLC, the name of the MME or a serving GPRS support node (SGSN) is determined by querying the HSS over the SLH interface, and the specific MME or SGSN that is currently serving the UE is retrieved.

5G GMLC is a combination of 5G GMLC, 4G GMLC and the Location Retrieval Function (LRF) function. It can serve both a 5G customer as well as a 4G customer location request. The GMLC contains functionality required to support the LCS. In one Public Land Mobile Network (PLMN) there may be more than one GMLC.

The GMLC is a first node an external LCS client accesses in a PLMN (i.e., the Le reference point is supported by the GMLC). AFs and NFs may access the GMLC directly or via the NEF. The GMLC may request routing information and/or target User Entity (UE) privacy information from the UDM via a Nudm interface. After performing authorization of an external LCS client or the AF and verifying interface or to the GMLC in another PLMN, an Ngmlc interface is used in the case of a roaming UE. Target UE's privacy profile settings shall always be checked in the UE's home PLMN prior to delivering a location estimate.

Visited GMLC (VGMLC) is the GMLC, which is associated with a serving node of the target UE. Home GMLC (HGMLC) is the GMLC residing in the target UE's home PLMN, which is responsible for controlling privacy checks of the target UE.

The Location Retrieval Function (LRF) is collocated with the GMLC and is responsible for retrieving or validating location information, providing routing and/or correlation information for the UE which has initiated an Internet Protocol Multimedia Subsystem (IMS) emergency session. For the 4G GMLC support, the GMLC is provided with a diameter interface Sh, Slh towards the HSS, and Slg towards MME.

The Location Management Function is a network entity in the 5G Core network (5GC) supporting the following functionality:
Authorization of the LCS client.
Providing location information of the concerned UE to an external client.
Immediate location request from the LCS client or Application Function (AF) or Network Exposure Function (NEF). An Immediate location request may be used for a Network Induced Location Request (NI-LR), Mobile Terminating Location Request (MT-LR) or Mobile Originating Location Request (MO-LR).
Deferred location request from the LCS client or the AF or the NEF. Deferred Location Request is only requested for the MT-LR.
Multiple UE location requests from an LCS client or AF or NEF.
Support to handle 4G customer's location requests through diameter interface.

The disclosed architecture enables enhancement of periodic location request, map support on UI for UE location, showing track support on the UI for UE periodic location, and list location API support to show all responses of periodic location request. Furthermore, the micro services of the GMLC plays a role in identification of the AMF (5G request) and the HSS for 4G. The UDM checks privacy data, and then it identifies the AMF and forwards the request to the identified AMF. The multiple GMLCs help as sub functionalities associated with the nodes. Hence each GMLC sub micro service interacts with its respective node.

In an embodiment, the GMLC function supports authorization functionality of the LCS client. The GMLC provides support for authorization and password management for the LCS client, which is connected through the Le interface. The GLMC processes immediate location requests from the LCS client, requests for location where the LCS server replies immediately to the LCS Client with the current location estimate if this can be obtained. Request for location contingent on some current or future events where the response from the LCS Server to the LCS Client may occur sometime after the request was sent.

In an embodiment, the GMLC provides location information of the concerned UE to the external client on a request basis. It supports various location requests such as providing location information, cancelling location information, and event notification. The GMLC supports concurrent location requests for the same target UE.

In an embodiment, the GMLC provides procedure support process of the Mobile Originated Location Requests (MO-LR). Based on the request for the updated location, it is processed for providing the location.

In an embodiment, is provided deferred 5GC-MT-LR procedure support. The GMLC support for periodic, triggered and UE available location events support. It supports the procedure of mobile-terminated location requests to provide exact location based on the requests. The GMLC also provides Location Deferred Request (LDR) support, which is provided only for the MT-LR.

In an embodiment, is provided a Network Function (NF) discovery support. The GMLC is responsible for integration and support of the interface towards the NRF for the NF discovery.

In an embodiment, is provided a Command Line Interface (CLI) Support. The GMLC provides alarm support and management through the CLI. It also provides the CLI support for FCAP management through FEOAM. The CLI provides capability to load commands dynamically during runtime and they are stored in a structure. The micro services commands may be executed for either a specific instance or all instances and their status is displayed.

In an embodiment, is provided support services for the LCS client. The GMLC supports following requests:
Standard location immediate request
Standard location immediate answer
Standard location immediate report

In an embodiment, is provided an Element Management System (i.e., Network Management System (NMS)). The NMS provides support for configuration management, backup, restore and alarm management for the GMLC. The NMS has a capability to define Key Performance Indicators (KPIs) based on various factors for a specific node, e.g., percentage, average, ratio, absolute values, i.e., number of registration calls, average response time, node availability percentage and the like. The NMS provides management of backup profiles. These profiles may be mapped with a kind of subcomponents of the network element. Apart from basic details on a type of component and frequency of backup, the profile design may provide flexibility to add a detailed folder list along with file names to be considered during a backup process. This provides flexibility to use different profiles for the same kind of components based on multiple requirements. The NMS supports an interface to view detailed backup history, backup restoration view, restoration logs and trace, and may act as a central coordinator for backup and restore procedures for all network elements with an advanced UE. The GMLC also supports integration with NMS plus for Fault, Configuration, Accounting, Performance and Security (FCAPS) management and NE management through FEOAM.

A set of NF services are defined for the GMLC:
The Ngmlc_Location service is used by consumer NFs (AMF.GMLC, NEF) to request location determination for a target UE.
The Ngmlc_Location_Provide location service is used by consumer NFs (GMLC, NEF). It provides UE location information to these consumer NFs.
The Ngmlc_Location_EventNotify service is used by Consumer NF (NEF). It allows the consumer NF (NEF) to get notified about geodetic and optionally civic location of a target UE on detection of certain events.
The Ngmlc_Location_CancelLocation service is used by Consumer NFs (GMLC, NEF). The consumer NF uses this service operation to cancel a deferred 5GC-MT-LR procedure for periodic or triggered location.

Below are discussed use cases for end-to-end call flows:

### 1. MT-LR Procedure

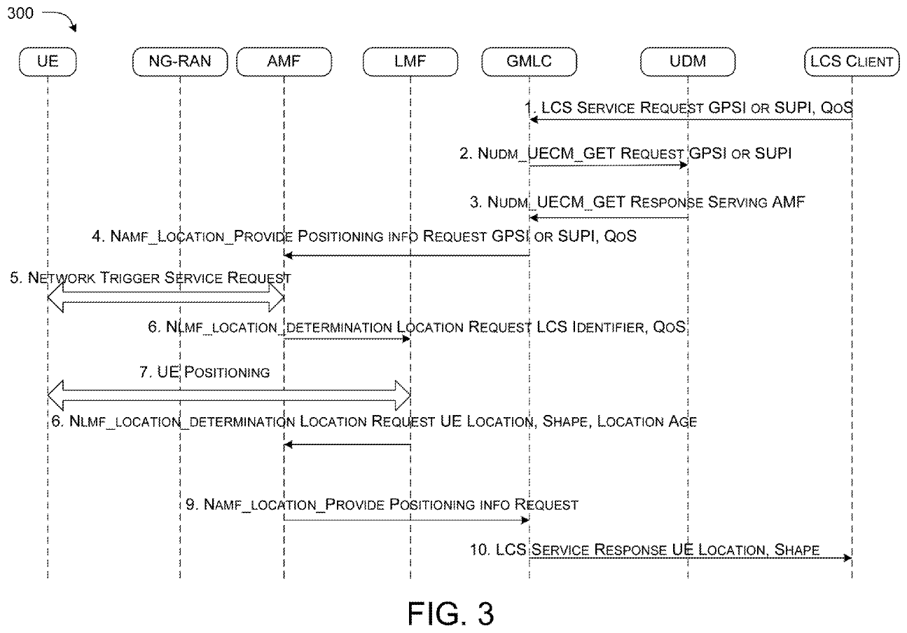

The MT-LR procedure is initiated by internal or external LCS clients and may be related to a service or application accessed by the UE, requests from regulatory agencies, or requests from the PLMN operator. FIG. 3 illustrates an end-to-end call flow 300 for executing the MT-LR procedure, in accordance with an embodiment of the present disclosure. The call flow is discussed below:
   External location services client sends a request to the GMLC for a location for the target UE identified by Generic Public Subscription Identifier (GPSI) or Subscription Permanent Identifier (SUPI). The request may include required Quality of Service (QOS), supported Geographical Area Description (GAD) shapes and client type.
   The GMLC invokes a Nudm_UECM_get service operation towards the home UDM of the target UE to be located with the GPSI or SUPI of this UE.
   The UDM returns network addresses of current serving AMF.
   The GMLC invokes Namf_Location_ProvidePositioningInfo service operation towards the AMF to request the current location of the UE. The service operation includes a subscription permanent identifier (SUPI) or the permanent equipment identifier (PEI) and an indication of a location request from an emergency services client.
   If the UE is in Connection Management (CM) IDLE state, the AMF initiates a network triggered service request procedure.
   Access and Mobility Management Function (AMF) selects the GMLC based on configuration and invokes NGMLC_Location_DetermineLocation service operation towards the GMLC to request the current location of the UE.
   The GMLC performs one or more of positioning procedures based on the QoS and the GMLC uses Namf_Communication_N1N2MessageTransfer service operation to request transfer of a positioning related N1 message to the UE or transfer of a network positioning message to the serving NG-RAN node for the UE.
   The GMLC returns the NGMLC_Location_DetermineLocation response towards the AMF to return the current location of the UE.
   The AMF returns the Namf_Location_ProvidePositioningInfo response towards the GMLC/LRF to return the current location of the UE.
   The GMLC sends the location service response to the external location services client.

### 2. MO-LR Procedure

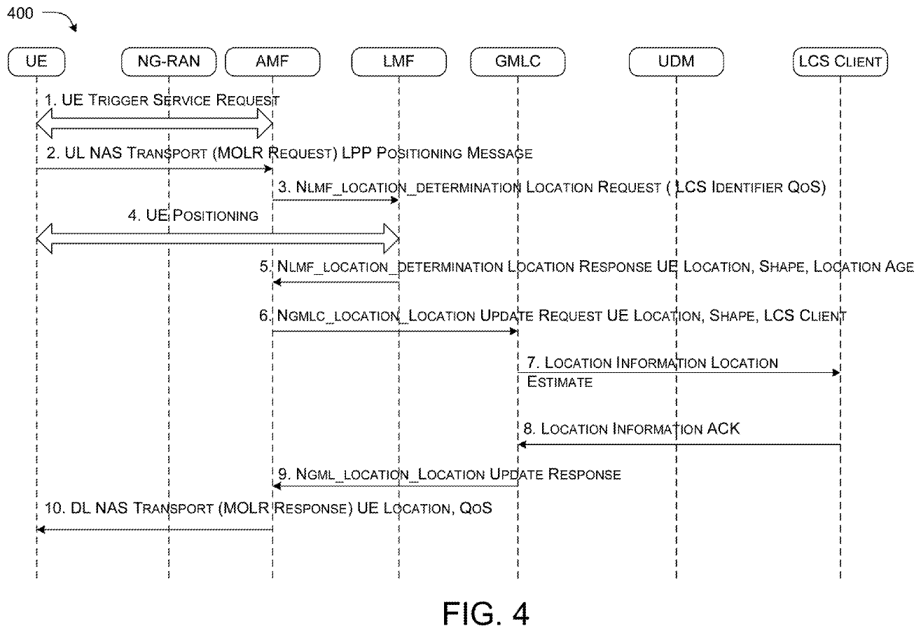

The Mobile Originated Location Requests (MO-LR) are initiated by the UE to determine its own location or to provide its location to an external client. FIG. 4 illustrates an end-to-end call flow 400 for executing the MO-LR procedure, in accordance with an embodiment of the present disclosure. The call flow is discussed below:
   If the UE is in CM-IDLE state, the UE instigates the UE triggered Service Request.
   The UE sends an MO-LR Request message included in a UL NAS TRANSPORT message. The MO-LR Request may optionally include an LPP positioning message.
   The AMF selects the GMLC based on configuration, and it invokes NGMLC_Location_DetermineLocation service operation towards the GMLC to request the current location of the UE.
   The GMLC performs one or more of positioning procedures based on the QoS and the GMLC uses the Namf_Communication_N1N2MessageTransfer service operation to request transfer of a positioning related N1 message to the UE or transfer of a network positioning message to the serving NG-RAN node for the UE.
   The GMLC returns the NGMLC_Location_DetermineLocation Response towards the AMF to return the current location of the UE.
   The AMF invokes the Ngmlc_Location_LocationUpdate service operation towards the GMLC.
   The GMLC transfers the location information to the LCS client as per local configuration.
   The LCS client sends the location information acknowledgement message to the GMLC.
   Upon receiving ACK from the client, the GMLC sends Ngmlc_Location_LocationUpdate service response to AMF.
   The AMF sends an MO-LR Response message included in a DL NAS TRANSPORT message. The response carries the location estimate requested by the UE.

### 3. NI-LR Procedure

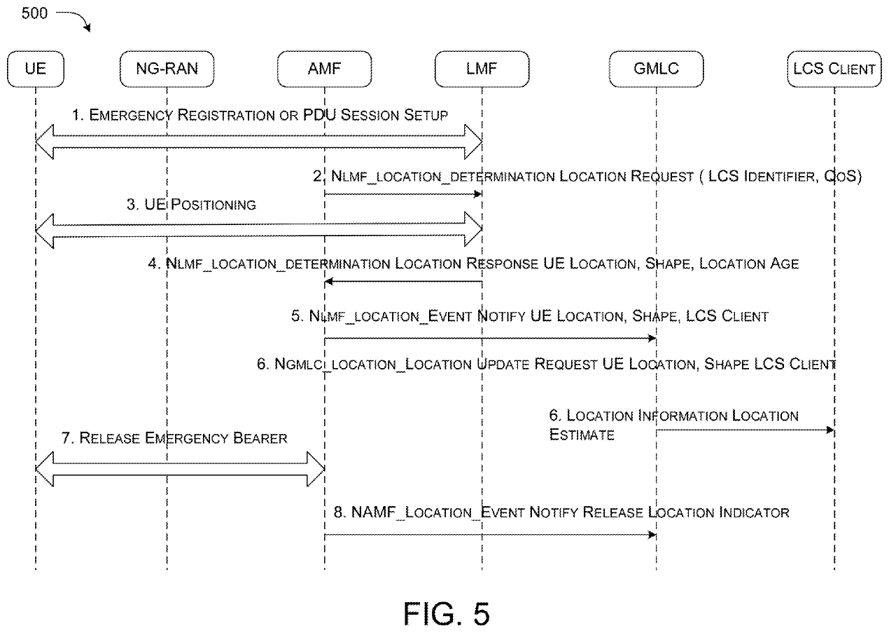

Network Induced Location Requests (NI-LR) are initiated by the AMF to determine a UE's location on behalf of a regulatory agency (e.g., to determine location during an IMS emergency call). FIG. 5 illustrates an end-to-end call flow 500 for executing the NI-LR procedure, in accordance with an embodiment of the present disclosure. The call flow is discussed below:
   The UE registers to the 5GC for emergency services or requests establishment of a PDU session related to an applicable regulatory service.
   The AMF selects the GMLC based on configuration, and it invokes NGMLC_Location_DetermineLocation service operation towards the GMLC to request the current location of the UE.
   The GMLC performs one or more of positioning procedures based on the QoS and the GMLC uses the Namf_Communication_N1N2MessageTransfer service operation to request transfer of a positioning related N1 message to the UE or transfer of a network positioning message to the serving NG-RAN node for the UE.
   The GMLC returns the NGMLC_Location_DetermineLocation response towards the AMF to return the current location of the UE.
   The AMF invokes the Namf_Location_EventNotify service operation towards the selected GMLC to notify the GMLC of an emergency session initiation. The service operation includes the SUPI or the PEI, and the generic public subscription identifier (GPSI) if available, the identity of the AMF, an indication of an emergency session and any obtained location.
   The GMLC forwards the location to an external emergency services client.
   For emergency services, the emergency services session and emergency PDU Session are released.
   For emergency services, the AMF invokes the Namf_Location_EventNotify service operation towards the GMLC to notify the GMLC that the emergency session is released to enable the GMLC.

Therefore, the disclosed system and method facilitates to provide a plurality of sub-GMLC micro services (sub nodes of a GMLC) that are attached individually with different nodes, specifically to each of external connected nodes. The disclosed architecture represents a node in 5G.

In an aspect, the present invention enables development, updation, deployment, and scaling of each of the plurality of microservices without affecting other services. Further, the present invention facilitates to perform more frequent software updates with improved reliability, uptime, and performance. The present invention can be implemented in a communication network for facilitation location services.

In an exemplary embodiment, the present invention discloses a method for providing location services in a network comprising a plurality of gateway mobile location center (GMLC) nodes. The method comprising sending, by at least one network element, a location assistance request to at least one GMLC node. The method comprising requesting, by the at least one GMLC node, an information related to a user equipment the (UE) based on the received location assistance request, from at least one unified data management (UDM). The information includes a routing information and a privacy information of the UE. The method comprising receiving, by the at least one GMLC node, the requested information from the at least one UDM. The method comprising verifying, by the at least one GMLC node, a privacy profile of the UE based on the received requested information. The method comprising delivering, by the at least one GMLC node, the location information of the UE to the at least one network element.

In an exemplary embodiment, the present invention discloses a system for providing location services in a network comprising a plurality of gateway mobile location center (GMLC) nodes. The system is configured to send, by at least one network element, a location assistance request to at least one GMLC node. The system is configured to request, by the at least one GMLC node, an information related to a user equipment the (UE) based on the received location assistance request, from at least one unified data management (UDM). The information includes a routing information and a privacy information of the UE. The system is configured to receive, by the at least one GMLC node, the requested information from the at least one UDM. The system is configured to verify, by the at least one GMLC node, a privacy profile of the UE based on the received requested information. The system is configured to deliver, by the at least one GMLC node, the location information of the UE to the at least one network element.

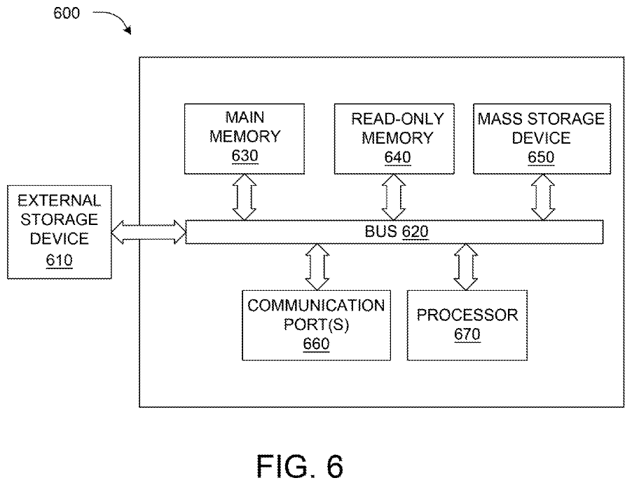

FIG. 6 illustrates an exemplary computer system 600 in which or with which embodiments of the present disclosure may be implemented. As shown in FIG. 6, the computer system 600 may include an external storage device 610, a bus 620, a main memory 630, a read-only memory 640, a mass storage device 650, communication port(s) 660, and a processor 670. A person skilled in the art will appreciate that the computer system 600 may include more than one processor and communication ports. The processor 670 may include various modules associated with embodiments of the present disclosure. The communication port(s) 660 may be any of an RS-232 port for use with a modem-based dialup connection, a 10/100

Ethernet port, a Gigabit or 10 Gigabit port using copper or fiber, a serial port, a parallel port, or other existing or future ports. The communication port(s) 660 may be chosen depending on a network, such a Local Area Network (LAN), Wide Area Network (WAN), or any network to which the computer system 600 connects.

The main memory 630 may be random access memory (RAM), or any other dynamic storage device commonly known in the art. The read-only memory 640 may be any static storage device(s) e.g., but not limited to, a Programmable Read Only Memory (PROM) chips for storing static information e.g., start-up or Basic Input/Output System (BIOS) instructions for the processor 670. The mass storage device 650 may be any current or future mass storage solution, which can be used to store information and/or instructions. Exemplary mass storage device 650 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks.

The bus 620 communicatively couples the processor 670 with the other memory, storage, and communication blocks. The bus 620 may be, e.g., a Peripheral Component Interconnect (PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor 670 to the computer system 600.

Optionally, operator and administrative interfaces, e.g., a display, keyboard, joystick, and a cursor control device, may also be coupled to the bus 620 to support direct operator interaction with the computer system 600. Other operator and administrative interfaces can be provided through network connections connected through the communication port(s) 660. Components described above are meant only to exemplify various possibilities. In no way should the aforementioned exemplary computer system 600 limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and a method for providing location determination services.

The present disclosure provides a plurality of microservices connected via a data structure.

The present disclosure provides a Gateway Mobile Location Center (GMLC) architecture consisting of multiple units running independently.

The present disclosure enables development, updation, deployment, and scaling of each of the plurality of microservices without affecting other services.

The present disclosure facilitates to perform more frequent software updates with improved reliability, uptime, and performance.

The present disclosure facilitates to provide location related services individually with each of the connected nodes in the system.

We claim:

1. A method for providing location services in a network comprising a plurality of gateway mobile location center (GMLC) nodes, the method comprising:
sending, by at least one network element, a location assistance request to at least one GMLC node (112);
requesting, by the at least one GMLC node (112), an information related to a user equipment the (UE) based on the received location assistance request, from at least one unified data management (UDM) (108), wherein the information includes a routing information and a privacy information of the UE;
receiving, by the at least one GMLC node (112), the requested information from the at least one UDM (108);
verifying, by the at least one GMLC node (112), a privacy profile of the UE based on the received requested information; and
delivering, by the at least one GMLC node (112), the location information of the UE to the at least one network element.

2. The method as claimed in claim 1, wherein the at least one network element includes a location services (LCS) client (116), at least one access and mobility management function serving (AMF) (104), and at least one network exposure function (NEF) (110).

3. The method as claimed in claim 1, further comprising determining if the received location assistance request is a request for 4G customer or a 5G customer.

4. The method as claimed in claim 1, further comprising performing, by the at least one GMLC node (112), an authorization of the at least one network element before delivering the location information of the UE.

5. The method as claimed in claim 1, wherein each GMLC node (112) of the plurality of GMLC nodes is connected independently to different network elements connected to the network.

6. A system (100) for providing location services in a network comprising a plurality of gateway mobile location center (GMLC) nodes (112), the system (100) is configured to:
send, by at least one network element, a location assistance request to at least one GMLC node (112);
request, by the at least one GMLC node (112), an information related to a user equipment the (UE) based on the received location assistance request, from at least one unified data management (UDM) (108), wherein the information includes a routing information and a privacy information of the UE;
receive, by the at least one GMLC node (112), the requested information from the at least one UDM (108);
verify, by the at least one GMLC node (112), a privacy profile of the UE based on the received requested information; and
deliver, by the at least one GMLC node (112), the location information of the UE to the at least one network element.

7. The system (100) as claimed in claim 6, wherein the at least one network element includes a location services (LCS) client (116), at least one access and mobility management function serving (AMF) (104), and at least one network exposure function (NEF) (110).

8. The system (100) as claimed in claim 6, further configured to determine if the received location assistance request is a 4G request or a 5G request.

9. The system as claimed in claim 6, further configured to determine perform, by the at least one GMLC node (112), an authorization of the at least one network element before delivering the location information of the UE.

10. The system as claimed in claim 6, wherein each GMLC node (112) of the plurality of GMLC nodes is connected independently to different network elements connected to the network.

11. A computer program product comprising a non-transitory computer-readable medium comprising instructions that, when executed by one or more processors, cause the one or more processors to perform a method for providing location services in a network comprising a plurality of gateway mobile location center (GMLC) nodes, the method comprising:
sending, by at least one network element, a location assistance request to at least one GMLC node (112);
requesting, by the at least one GMLC node (112), an information related to a user equipment the (UE) based on the received location assistance request, from at least one unified data management (UDM) (108), wherein the information includes a routing information and a privacy information of the UE;
receiving, by the at least one GMLC node (112), the requested information from the at least one UDM (108);
verifying, by the at least one GMLC node (112), a privacy profile of the UE based on the received requested information; and
delivering, by the at least one GMLC node (112), the location information of the UE to the at least one network element.
